(19) United States
(12) Patent Application Publication
(10) Pub. No.: US 2023/0179045 A1
(43) Pub. Date: Jun. 8, 2023

(54) PERMANENT MAGNET MOTOR WITH WRAPPING

(71) Applicant: Tesla, Inc., Austin, TX (US)

(72) Inventors: Leif Eric Olsen, San Jose, CA (US); David Nelson, Menlo Park, CA (US); Konstantinos Laskaris, Burlingame, CA (US); Hao Ge, Palo Alto, CA (US); Ethan Filip, Indian Trail, NC (US); Christian Vega, San Francisco, CA (US); Pierre Pellerey, San Francisco, CA (US); Vasileios Papanikolaou, Athens (GR)

(21) Appl. No.: 17/923,204

(22) PCT Filed: Apr. 30, 2021
(86) PCT No.: PCT/US2021/030276

§ 371 Date: Nov. 3, 2022

Related U.S. Application Data
(60) Provisional application No. 63/019,848, filed on May 4, 2020.

(51) Int. Cl. H02K 1/28; H02K 1/276; H02K 7/04; H02K 15/03

(52) U.S. Cl. CPC H02K 1/28; H02K 1/276; H02K 7/04; H02K 15/03

(57) ABSTRACT

The present disclosure relates to electric motors. The electric motor assembly may include a rotor mounted coaxially on a shaft. The rotor may include a center lamination stack mounted on a balance ring. The center lamination stack may have slots along the outer circumference which hold pole pieces attached to a plurality of magnets. The magnets may be situated between the pole pieces and the center lamination stack. The magnets may not be fully enclosed by the metal body of the rotor. The described components of the rotor may be encased in a wound fiber sleeve. The rotor is rotably mounted within a stator.

### TECHNICAL FIELD

The present disclosure relates to electric motors and more specifically to the configuration of a rotor in an electric motor.

### BACKGROUND

The trend towards designing and building fuel efficient, low or zero emission on-road and off-road vehicles has increased dramatically in recent years, with significant emphasis being placed on the development of hybrid and all-electric vehicles. This has led, in turn, to a greater emphasis being placed on electric motors, either as the sole source of propulsion (e.g., all-electric vehicles) or as a secondary source of propulsion in a combined propulsion system (e.g., hybrid or dual electric motor vehicles). The electric motor in such an application may utilize either an AC or DC permanent magnet motor design or an AC induction motor design. Regardless of the type of electric motor, motors are generally designed for a particular application to achieve the desired efficiency, torque density, or high speed power with an acceptable motor size and weight.

### SUMMARY

The present disclosure relates to electric motors. The electric motor assembly includes a rotor mounted coaxially on a shaft. In one embodiment, the rotor may include a center lamination stack mounted on a balance ring. The center lamination stack may have slots along the outer circumference that hold pole pieces coupled with a plurality of magnets. The magnets may be situated between the pole pieces and the center lamination stack. The pole pieces may further comprise fixturing slots, such that a plurality of embedded locating dowels which protrude from the surface of the balance ring can secure the pole pieces during a sleeve winding process in one embodiment. In one embodiment, the described components of the rotor are encased in a wound fiber sleeve that holds the pole pieces in place around the periphery of the rotor. The rotor is rotably mounted within a stator to form a permanent magnet motor.

### BRIEF DESCRIPTION OF THE DRAWINGS

FIG. 1 shows an example partial axial cross section of an electric motor, according to certain embodiments of the present disclosure.

FIG. 2 illustrates a perspective view of a sleeved rotor, according to certain embodiments of the present disclosure.

FIG. 3 illustrates a perspective view of the components of a rotor contained within a rotor sleeve, according to certain embodiments of the present disclosure.

FIG. 4 illustrates an exemplary axial view of a sleeved rotor, according to certain embodiments of the present disclosure.

FIG. 5A shows an exploded view of the internal components of a rotor, according to certain embodiments of the present disclosure.

FIG. 5B shows a perspective view of a balance ring and lamination stack assembly on a motor shaft, according to certain embodiments of the present disclosure.

FIG. 6 illustrates a lateral cross section of a rotor, according to certain embodiments of the present disclosure.

FIG. 7 illustrates a motor performance graph comparing motor speed to torque for both a conventional permanent magnet motor and a permanent magnet motor having a carbon sleeve according to certain embodiments of the present disclosure.

### DETAILED DESCRIPTION

Embodiments relate to a permanent magnet motor with a rotor having magnetic pieces disposed around the periphery of the rotor and held in place using a wound fiber wrap around the exterior circumference of the rotor. For example, the wound fiber wrap may be made of carbon fiber or other fiber materials. In one embodiment, the magnetic pieces are not held in the rotor using metallic components and the magnets are not fully enclosed within the rotor. The magnetic fields created by a stator acting on the magnetic pieces in the rotor may be stronger in comparison to conventional rotors with magnetic pieces embedded into metal because the wound fiber wrap and lack of metal components may provide a lower level of interference with the magnetic fields generated by the stator. In one embodiment, there are limited, or no, metal components disposed between the magnetic pieces and the center portion of the rotor. The permanent magnet motor disclosed herein may therefore offer improved performance over conventional designs due to reduced magnetic flux leakage.

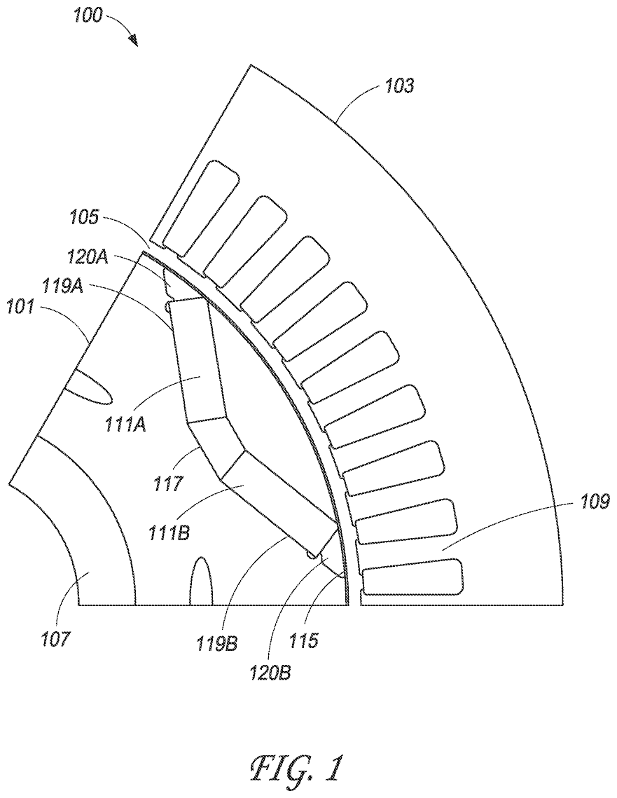

FIG. 1 shows an axial cross-sectional view of a permanent magnet motor 100 in accordance with one embodiment of the present disclosure. The illustration provided in FIG. 1 is simplified for the sake of explanation, this view omitting windings and other components. As shown, a rotor 101 is surrounded by a stator 103. A plurality of windings (not shown) is disposed around each of the stator teeth 109. In various embodiments the windings are copper, but other materials are within the scope of the invention. The windings define a plurality of poles, for example, a three-phase, four pole design or a six pole design.

As shown, the rotor 101 is encircled by the stator 103, the two being separated by an air gap 105. A shaft 107 is coupled to the rotor 101, the shaft 107 providing a means for coupling the motor 100 to various devices and mechanisms, such as an axle, a gearbox and the like within an electric vehicle. The air gap 105 between the stator 103 and rotor 101 is sized to obtain a desired level of magnetic inductance from the stator 103 onto the rotor 101. The air gap 105 also may affect the saturation levels and harmonic levels of the magnetic flux proximal the air gap 105. In general, the smaller the air gap 105, the stronger the magnetic flux between the stator 103 and rotor 101.

As shown, a series of magnets 111A and 111B are disposed in a “V” shaped configuration around the periphery of the rotor 101. The configuration of the magnets 111A and 111B has an apex 117 positioned towards the shaft 107 and two arms 119A and 119B that point towards the stator 103. The end of each of the arms 119A and 119B is adjacent to an opening 120A and 120B which provides an empty space between the arms of the magnets and the air gap 105. This air pocket, or empty space, allows the magnetic flux from the rotor into the stator with minimal loss of permanent magnet flux. the magnets 111A and 111B are not embedded into a solid metal body of the rotor 101. It should be appreciated that the illustration is just one example of how the magnets 111A and 111B may be oriented and that the magnets 111A and 111B may be arranged differently in other embodiments. A wound fiber sleeve 115 is shown encircling the rotor to hold the magnets 111A and 111B in place as the rotor 101 spins within the stator 103. It should be understood that other magnet configurations in which the magnets are not fully enclosed by the rotor may also reduce loss of permanent magnet flux.

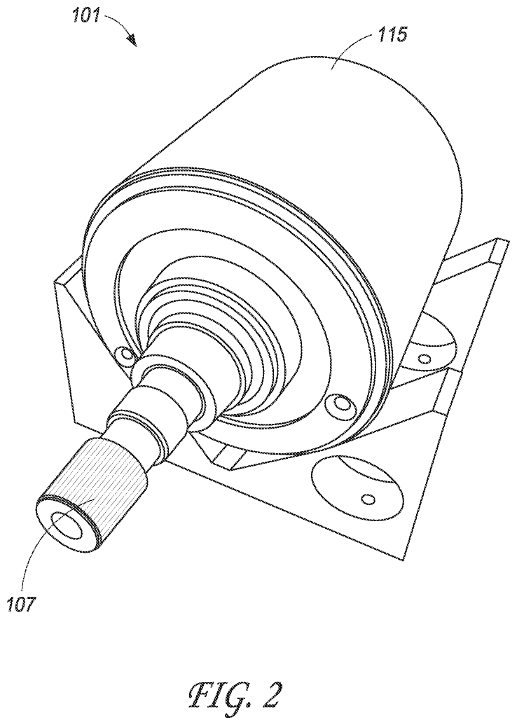

FIG. 2 shows an assembled rotor 101 in accordance with the invention. The rotor 101 is encased in the wound fiber sleeve 115, as opposed to traditional iron bridges. The shaft 107 is coupled to the rotor 101, providing a means for coupling the motor to various devices and mechanisms, such as an axle, a gearbox and the like within an electric vehicle. In some embodiments, the wound fiber sleeve 115 comprises carbon fiber that is wound around the rotor while pre-tensioned. In one embodiment, the sleeve has a thickness of 0.1-2 mm. In other embodiments, the sleeve has a thickness of 0.3, 0.4, 0.5, 1, 2, 3, 4, or 5 mm. Unlike existing methods of producing wound fiber rotor sleeves, the present wound fiber sleeve production method strives to minimize the thickness of the sleeve by subjecting the fiber to a relatively higher tension during the winding process. To minimize sleeve thickness, the fiber may be wound onto the rotor while being pre-tensioned. In some embodiments, the fiber may be wound using a unique godet system having godet rolls that can wind fiber around the periphery of the rotor under tension with minimal damage to the fiber.

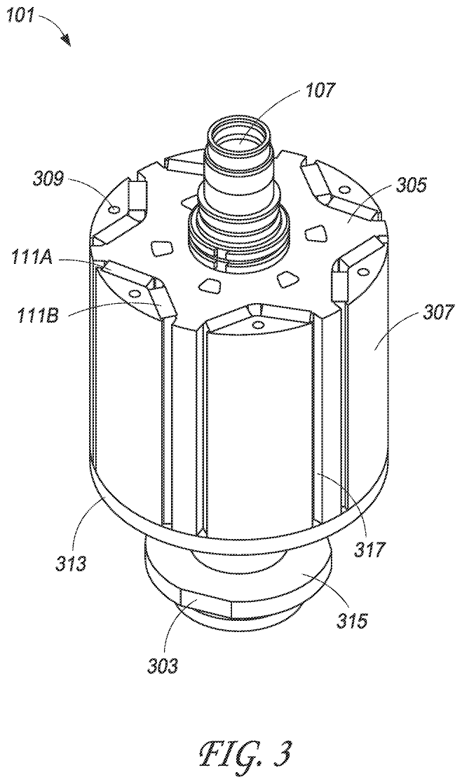

FIG. 3 illustrates an exemplary embodiment of the fully assembled inner components of the rotor 101 (with the sleeve removed) in accordance with the present disclosure. The rotor 101 encircles the shaft 107 and comprises a balance ring 313 at the lower end, center lamination stack 305, pole pieces 307, and magnets 111A and 111B. The shaft 107 has a coaxial disc 315 protruding from the lower end of the shaft 301. The coaxial disc 315 has one or more flat segments (“flats”) 303 along its circumference. The flats 303 serve as a gripping area for filament winder equipment during rotor manufacture, specifically during the sleeve winding process wherein the filament winder equipment grips the shaft to rotate the rotor. In some embodiments, the disc may not have flats 303 and may instead have other gripping features as appropriate for the filament winder equipment. In some embodiments, the disc may not have flats or any other gripping features, such that the disc has an uninterrupted outer circumference. In this figure, the wound fiber sleeve is not shown surrounding the rotor 101.

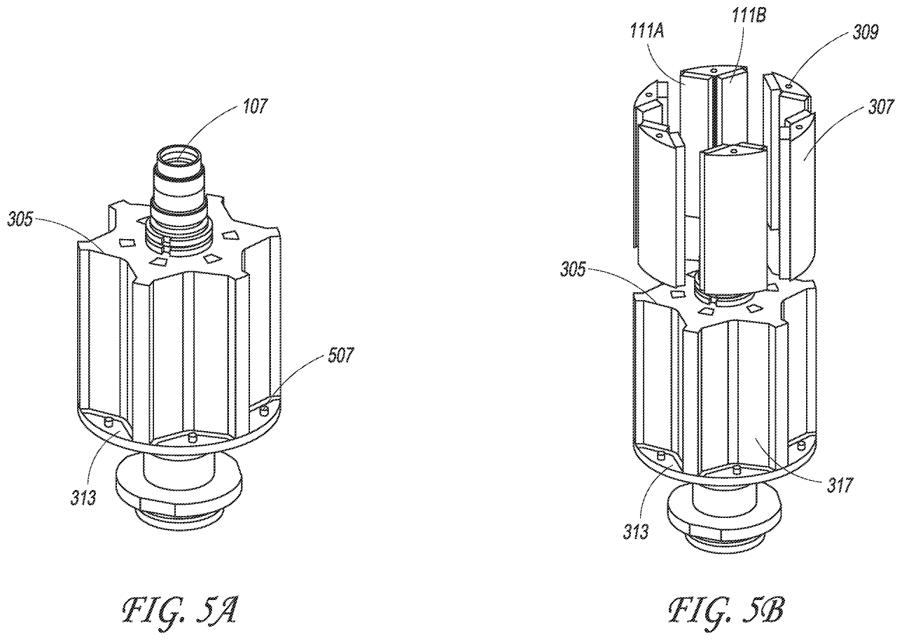

In continued reference to FIG. 3, the center lamination stack 305 is mounted to the balance ring 313. The center lamination stack 305 has a plurality of slots 317 along its outer lateral edge that run the entire length of the center lamination stack 305. The pole pieces 307 each are coupled with a plurality of magnets 111. When assembled, the pole pieces 307 and magnets 311 fit into the slots 317 of the center lamination stack 305 such that the magnets 111 are pressed between the pole piece 307 and the center lamination stack 305. This can be seen more fully with reference to FIG. 5 below. It should be noted that in some embodiments the pole pieces 307 and the center lamination stack 305 are not connected by a steel bridge or other metal component, as in conventional rotor designs. Removal of all metal connections between the pole pieces 307 and center lamination stack 305 reduces flux leakage through the connection.

In some embodiments, each pole piece 307 has a fixturing slot 309, which is configured to interlock with a locating dowel (not shown) in the balance ring. The fixturing slot 309 and locating dowel may serve as securing features during rotor manufacture. In some embodiments, the magnets 111, pole pieces 307, and center lamination stack 305 are fixtured to each other during assembly. In such embodiments, the pole pieces 307 may not have fixturing slots 309. Given the high speed at which the rotor components spin during the sleeve winding process, the securing features may keep the pole pieces 307 close against the center lamination stack 305 during manufacturing.

In one embodiment, the sleeve winding process begins with placing the rotor of FIG. 3 onto a rotating mechanism that is connected to a filament tensioning system such as godet rolls. For example, the tensioning system may include a spool of carbon fiber that runs through a bath of epoxy resin and is then wound onto the outer circumference of the rotor mechanism of FIG. 3 as it rotates in one direction. In another example, the tensioning system may apply resin onto the spool during the dispensing process. This system allows the sleeve to be wound across the length of the rotor in a predetermined pattern and with a predetermined number of fiber wrappings to create a particular thickness of sleeve.

It should be realized that the sleeve which surrounds the rotor is not necessarily made of carbon fiber. Other similar materials may also be wound around the rotor and used to surround the rotor and maintain the positions of the pole pieces and magnets. For example, other composites made from other types of fibers, such as ceramic, fiberglass, polypropylene, polyethylene, polyetheretherketone (PEEK) and similar plastics may be embedded into a resin to form a durable material that can be used to form a tensioned sleeve around the rotor. In further example, a combination of materials may be used to make the sleeve, such as carbon fiber embedded into a plastic.

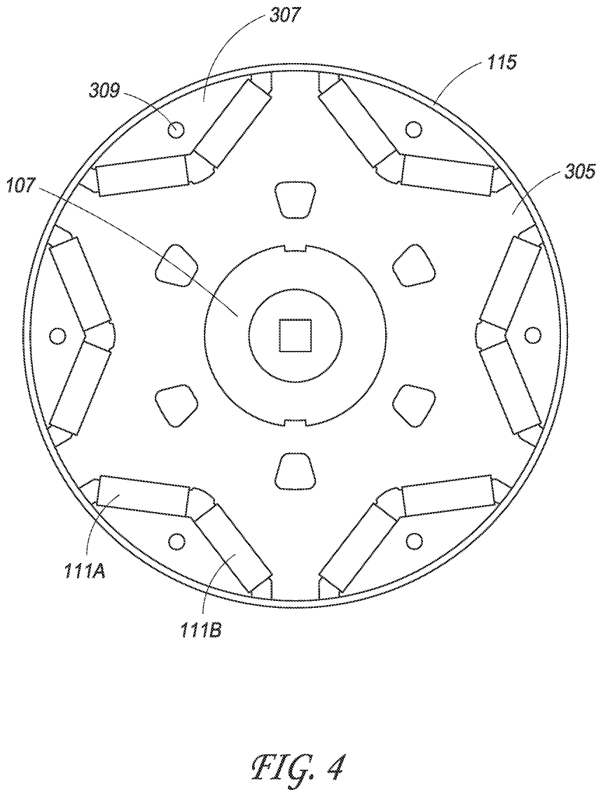

FIG. 4 shows an axial cross-sectional view of a fully assembled rotor according to the present disclosure. The assembly is coaxial with the shaft 107, as illustrated by the shaft 107 running through the center of the rotor. From the axial view, the magnets 111A and 111B can be seen pressed flush against both the pole pieces 307 and center lamination stack 305. In some embodiments, magnets placed on adjacent faces of a pole piece (for example, a pair of magnets forming a “V” shaped configuration) are separated from each other by an air gap. Each pole piece 307 may comprise the fixturing slot 309 that interlocks with a locating dowel so the pole piece 307 is secure during the winding process. The wound fiber sleeve 115 may encase the entire assembly. Of course, it should be realized that the locating dowel may not be necessary, and embodiments of a motor may not include any locating dowels or rods.

FIG. 5A shows a partial assembly of the rotor 101 according to the present disclosure. In this partial assembly, only the center lamination stack 305 and balance ring 313 have been mounted onto the shaft 107. As illustrated, locating dowels 507 are embedded in the balance ring 313 and protrude beyond the face of the balance ring 313. A set of locating dowels 507 may protrude a small distance from the face of the balance ring 313 that contacts the center lamination stack 305.

FIG. 5B shows an exploded view of the inner assembly of a rotor, according to the present disclosure. FIG. 5B shows how the pole pieces 307 and magnets 111A and 111B may fit into a plurality of the slots 317 and couple with each other and the center lamination stack 305. As illustrated, in some embodiments, the magnets 111A and 111B are fixtured to the pole pieces 307 but not the center lamination stack 305, as illustrated in FIG. 5B. In one embodiment, each pole piece 307 is a similar length as the length of the center lamination stack 305. Each pole piece 307 may be coupled with two magnets 111A and 111B that are also of a similar length. In other embodiments, the magnets 111A and 111B may be shorter and more magnets 111A and 111B can be used to occupy the length of the pole piece 307 to which they are coupled. In yet other embodiments, the magnets 111A and 111B may be a different shape than the rectangular prism depicted in FIG. 5B.

In continued reference to FIG. 5B, each pole piece 307 may comprise a fixturing slot 309 to secure the pole piece 307 to the balance ring 313. In one embodiment, the fixturing slot 309 runs through the entire length of the pole piece 307. In other embodiments, the fixturing slot 309 may end partway through the pole piece 307. In embodiments where the rotor contains two balance rings, one on each end of the center lamination stack 305, the pole pieces 307 may have either one fixturing slot 309 running the length of the pole pieces 307, or the pole pieces 307 may have one fixturing slot 309 on each end of the pole piece 307, with each fixturing slot 309 terminating within the length of the pole piece 307. As described herein, in some embodiments, the pole pieces 307, magnets 111A and 111B, and the center lamination stack 305 may be fixtured to each other during manufacture, such that the assembly does not have fixturing slots 309 or locating dowels 507.

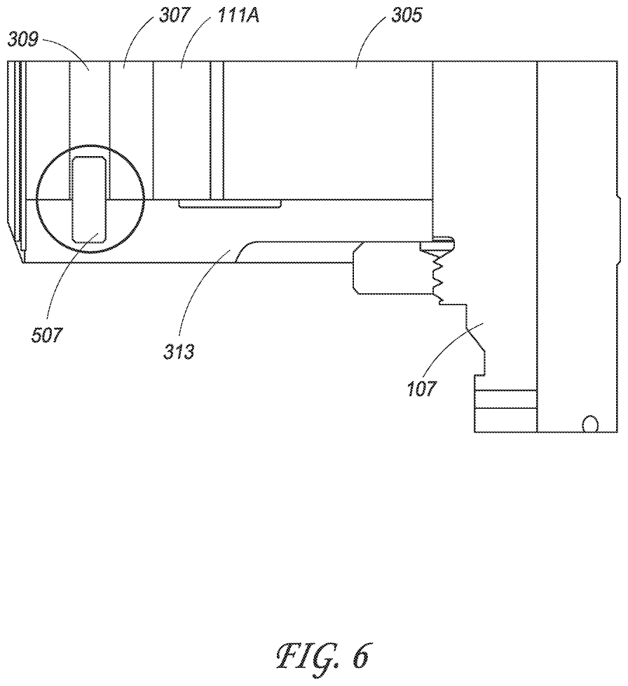

FIG. 6 is half of a lateral cross section of a rotor, in accordance with the present disclosure. Addressing components starting from the shaft 107 and radiating outward, FIG. 6 shows the center lamination stack 305, the magnet 111A coupled with the pole piece 307, and the locating dowel 507 interlocked with the fixturing slot 309 in the pole piece 307. The entire assembly is mounted on the balance ring 313. This illustration shows how the locating dowel 507 may be embedded in the balance ring 313 and only protrudes from the surface of the balance ring 313 that contacts the rotor assembly.

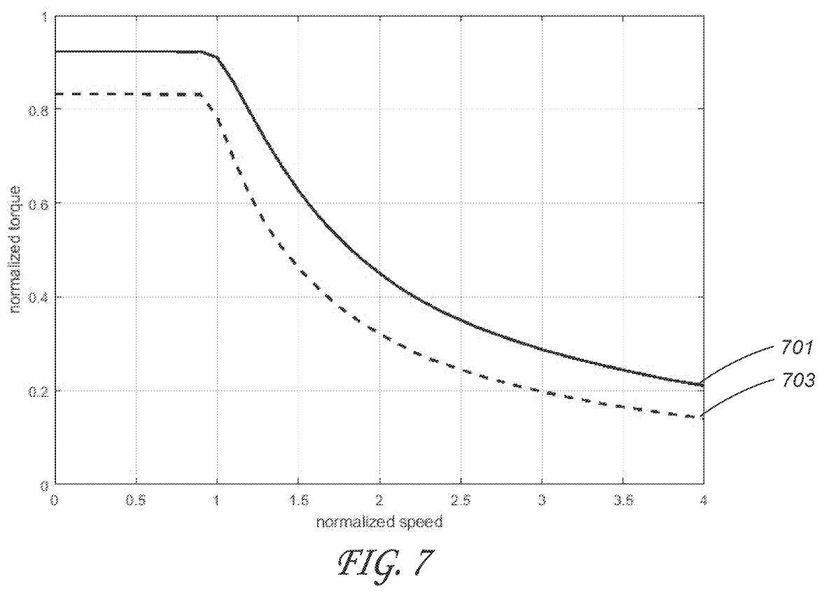

FIG. 7 compares torque generation of the disclosed sleeved motor against a conventional permanent magnet motor. The solid line 701 tracks the amount of torque generated at various speeds by the disclosed sleeved motor. The dotted line 703 represents the torque generated at the same speeds by a conventional permanent magnet motor. As shown, the sleeved motor can produce more torque than the conventional motor at the same speeds. The sleeved motor can have a higher peak torque because the elimination of ribs and bridges allows for greater fundamental flux.

The sleeved motor can also produce more power than a conventional motor at the same speeds. Higher fundamental flux to slot harmonic ratios lead to greater motor efficiency at high speeds, at both low and high torque. Further, the carbon wrapped motor design can reduce or eliminate leakages, which allows for better utilization of an inverter current and leads to a peak power increase of up to 25% or more. At high speeds, the sleeved motor can generate more power as compared to a conventional motor without increasing the usage of permanent magnet.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, a person of ordinary skill in the art will recognize that changes may be made in form and detail without departing from the scope of the present disclosure. Thus, the present disclosure is limited only by the claims.

In the foregoing specification, the disclosure has been described with reference to specific embodiments. However, as one skilled in the art will appreciate, various embodiments disclosed herein can be modified or otherwise implemented in various other ways without departing from the spirit and scope of the disclosure. Accordingly, this description is to be considered as illustrative and is for the purpose of teaching those skilled in the art the manner of making and using various embodiments of the disclosed motor assembly. It is to be understood that the forms of disclosure herein shown and described are to be taken as representative embodiments. Equivalent elements, materials, processes or steps may be substituted for those representatively illustrated and described herein. Moreover, certain features of the disclosure may be utilized independently of the use of other features, all as would be apparent to one skilled in the art after having the benefit of this description of the disclosure. Expressions such as “including”, “comprising”, “incorporating”, “consisting of”, “have”, “is” used to describe and claim the present disclosure are intended to be construed in a non-exclusive manner, namely allowing for items, components or elements not explicitly described also to be present. Reference to the singular is also to be construed to relate to the plural.

Further, various embodiments disclosed herein are to be taken in the illustrative and explanatory sense, and should in no way be construed as limiting of the present disclosure. All joinder references (e.g., attached, affixed, coupled, connected, and the like) are only used to aid the reader's understanding of the present disclosure, and may not create limitations, particularly as to the position, orientation, or use of the systems and/or methods disclosed herein. Therefore, joinder references, if any, are to be construed broadly. Moreover, such joinder references do not necessarily infer that two elements are directly connected to each other.

Additionally, all numerical terms, such as, but not limited to, “first”, “second”, “third”, “primary”, “secondary”, “main” or any other ordinary and/or numerical terms, should also be taken only as identifiers, to assist the reader's understanding of the various elements, embodiments, variations and/or modifications of the present disclosure, and may not create any limitations, particularly as to the order, or preference, of any element, embodiment, variation and/or modification relative to, or over, another element, embodiment, variation and/or modification.

It will also be appreciated that one or more of the elements depicted in the drawings/figures can also be implemented in a more separated or integrated manner, or even removed or rendered as inoperable in certain cases, as is useful in accordance with a particular application. Additionally, any signal hatches in the drawings/figures should be considered only as exemplary, and not limiting, unless otherwise specifically specified.

What is claimed is:

1. An electric motor comprising:
a stator configured to generate a magnetic field and accept a rotor into a central opening; and
a rotor sized to fit within the central opening, wherein the rotor comprises a plurality of magnets and is wrapped with a wound fiber sleeve on its outer circumference, wherein the magnets are not fully enclosed by the rotor.

2. The electric motor of claim 1, wherein the rotor comprises a centrally located shaft with a first end and a second end, wherein the first end of the shaft comprises a radially protruding disc.

3. The electric motor of claim 2, wherein the circumference of the disc is interrupted by a plurality of flat edges.

4. The electric motor of claim 2, further comprising a balance ring adjacent to the first end of the shaft and a plurality of locating dowels in the balance ring.

5. The electric motor of claim 4, wherein the locating dowels are embedded in a circular pattern concentric with the balance ring.

6. The electric motor of claim 1, wherein the plurality of magnets is coupled to a plurality of pole pieces such that each pole piece is coupled with at least two magnets.

7. The electric motor of claim 6, wherein each of the pole pieces interlocks with a plurality of slots in a center lamination stack such that the plurality of magnets is oriented between an inner edge of the pole piece and an outer edge of the center lamination stack.

8. The electric motor of claim 7, further comprising a plurality of locating dowels running through the rotor via fixturing slots on an edge of each pole piece.

9. The electric motor of claim 1, wherein the wound fiber sleeve comprises a wound carbon fiber sleeve.

10. The electric motor of claim 1, wherein there is an empty space between an end of each of the plurality of magnets and the wound fiber sleeve.

11. A method of assembling a rotor for an electric motor, comprising:
inserting magnetic pieces into slots in an outer circumference of a rotor fixture;
positioning the magnetic pieces with locating dowels in the rotor fixture;
tensioning non-metallic fibers on a filament winder equipment; and
winding the non-metallic fibers under tension around the rotor to hold the magnetic pieces in position on the rotor fixture.

12. The method of claim 11, to tension the non-metallic fibers, further comprising securing filament winder equipment to a plurality of flat edges along a circumference of a disc on one end of the rotor fixture.

13. The method of claim 11, wherein positioning the magnetic pieces with locating dowels comprises securing the magnetic pieces flush against a surface of the rotor fixture.

14. A method of assembling a rotor for an electric motor, comprising:
inserting magnetic pieces into slots in an outer circumference of a lamination stack;
winding non-metallic fibers under tension around the rotor to hold the magnetic pieces in position in the slots.

15. The method of claim 14, further comprising interlocking the magnetic pieces with locating dowels in a rotor fixture.

16. The method of claim 14, further comprising fixturing the magnetic pieces to the lamination stack.

17. The method of claim 14, to wind the non-metallic fibers, further comprising:
securing filament winder equipment to a plurality of flat edges along a circumference of a disc on one end of a rotor fixture; and
tensioning non-metallic fibers on the filament winder equipment.
